(19) United States
(12) Patent Application Publication
(10) Pub. No.: US 2018/0347794 A1
(43) Pub. Date: Dec. 6, 2018

(54) PORTABLE LIGHT HOLDING APPARATUS

(71) Applicant: Matthew Sieckert, Elbow Lake, MN (US)

(72) Inventor: Matthew Sieckert, Elbow Lake, MN (US)

(21) Appl. No.: 15/994,064

(22) Filed: May 31, 2018

Related U.S. Application Data
(60) Provisional application No. 62/513,765, filed on Jun. 1, 2017.

(51) Int. Cl. F21V 21/088; F21V 21/096; F21L 4/04

(52) U.S. Cl. CPC F21V 21/0885; F21L 4/045; F21V 21/0965

(57) ABSTRACT

A portable light holding apparatus comprising a body comprising a light and an attachment arrangement that is non-reliant on the body comprising the light for attachment functioning, wherein the attachment arrangement is usable in a front position mode, and in a reverse position mode, wherein the body comprising the light is adjustable in angle relative to the attachment arrangement.

### BACKGROUND

### a. Field

This disclosure relates to a portable light holder. In particular, the instant disclosure relates to apparatuses for holding a portable light.

### b. Background Art

Flashlight users in many situations have the need to apply portable lighting to the subject of their attention and, particularly, to aim a beam of light, such as from a flashlight, on a particular portion of the subject while the hands remain free to perform operations needed for the activity at hand. It is therefore often desired to adjustably and temporarily fix the flashlight in space at a particular location and orientation. However, the light must be attached to or rest upon something if it is not held by the user's hand, and it is not generally the case that the subject or site has a specialized provision for this purpose.

A common but inconvenient solution to this problem is for the user to hold the butt of the flashlight in his or her mouth. Other times attempts to prop the flashlight in the desired position produce results that fall far short of that desired. Some would say the person should carry a head-lamp type of light source but that solution requires carrying a device that is less convenient to carry than a small pocket sized flashlight. It also requires a less than convenient method of mounting the light to the user's head.

### BRIEF SUMMARY

The instant disclosure, in at least one embodiment, an apparatus comprising a body comprising a light, and an attachment arrangement that is non-reliant on the body comprising the light for attachment functioning, wherein the attachment arrangement is usable in a front position mode, and in a reverse position mode, wherein the body comprising the light is adjustable in angle relative to the attachment arrangement.

### BRIEF DESCRIPTION OF THE DRAWINGS

FIG. 1A is a side view of a flashlight holding apparatus in a stowed position, consistent with embodiments in the present disclosure.

FIG. 1B is a side view of the flashlight holding apparatus of FIG. 1A rotated 90° about a longitudinal axis of the flashlight holding apparatus, consistent with embodiments in the present disclosure.

FIG. 2 is a side view of components of an embodiment of a flashlight holding apparatus consistent with embodiments in the present disclosure.

FIG. 3 is a side view of a flashlight holding apparatus in a partially pivoted position, consistent with embodiments in the present disclosure.

FIG. 4 is a side view of a flashlight holding apparatus coupled with a brim of a hat, consistent with embodiments in the present disclosure.

FIG. 5 is a side view of a flashlight holding apparatus coupled with a pocket, consistent with embodiments in the present disclosure.

FIGS. 6A-C are side views of three representative configurations of a flashlight holding apparatus using a magnet to couple with an object, consistent with embodiments in the present disclosure.

### DETAILED DESCRIPTION OF EMBODIMENTS

The instant disclosure relates to a portable light holder. In particular, the instant disclosure relates to apparatuses for holding a portable lights, and more specifically, to a pivoting attachment for the flashlight utilizing a bi-directional spring clip and magnet. This attachment allows the light to be temporarily fixed by the clip in one of two opposite orientations to the edge of a flat material or by the magnet to a flat ferrous material. Once fixed to the supporting material, the forward component of the flashlight can then be pivoted to the desired angle where the friction preload in the movable joint will hold the selected angle, training the beam of light on the subject desired. In this way the light can, for example, function as a temporary head lamp if the user is wearing a baseball cap, it can be temporarily held to the outside of a shirt pocket, or to the side of an electrical breaker panel by the magnet. Details of the various embodiments of the present disclosure are described below with specific reference to the figures.

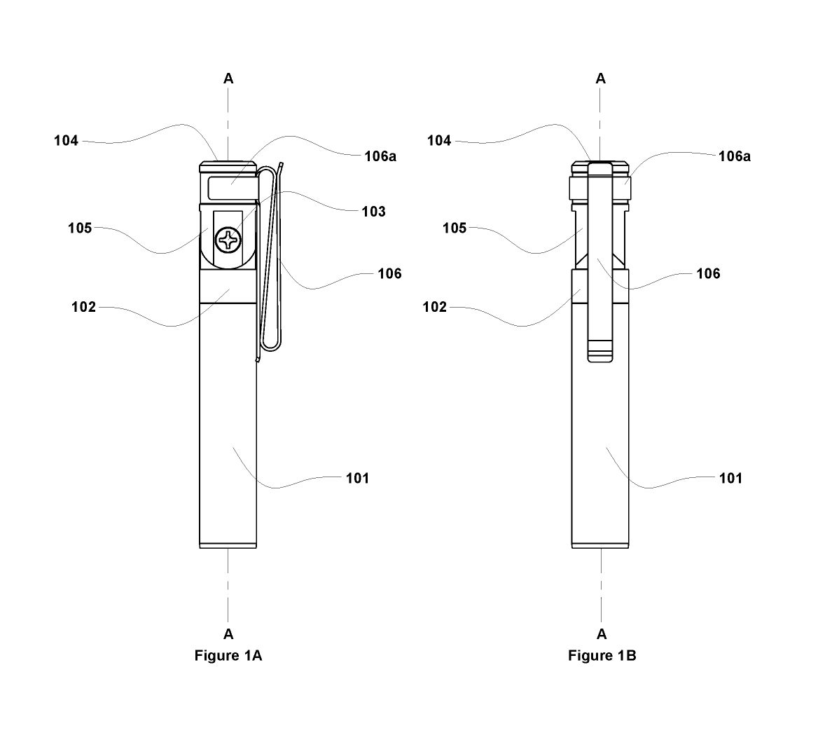

Referring now to the drawings wherein like reference numerals are used to identify similar components in the various views, FIG. 1A is a side view of a flashlight holding apparatus in a stowed position, consistent with embodiments in the present disclosure. A flashlight holding apparatus 100 can comprise a forward flashlight component 101, a forward attachment component 102, a hinge pivot element 103, a magnet 104 coupled with a rear attachment component 105, and a spring clip 106 (i.e., a bi-directional spring clip).

While in the stowed position (i.e., a first position) the rear attachment component 105 is pivotally coupled, by the hinge pivot element 103, with the forward attachment component 102 where a longitudinal axis of the rear attachment component 105 and the forward attachment component 102 are each aligned with the line A-A. In the stowed position the spring clip 106 is fully against the side of the forward flashlight component 101 and the forward attachment component 102. If a detent feature is included in the flashlight holding attachment, it can be engaged in this stowed position to maintain the stowed position with a positive force.

The spring clip 106 can be coupled with the flashlight holding apparatus 100 at any suitable location, including the forward flashlight component 101 or the rear attachment component 105. The spring clip 106 can be coupled using a circular portion 106a as shown in FIG. 1A or with other suitable attachment elements (e.g., a slot for engaging a portion of the spring clip 106, etc.). The circular portion 106a can be a full circle (e.g., in contact with an entire circumference of a portion of the rear attachment component 105) or a partial circle (e.g., two “C”-shaped portions that each contact a portion of the circumference of the rear attachment component 105).

FIG. 1B is a side view of the flashlight holding apparatus of FIG. 1A rotated 90° about a longitudinal axis of the flashlight holding apparatus, consistent with embodiments in the present disclosure. As described above, in the stowed position shown in FIGS. 1A and 1B, rear attachment component 105 the hinge pivot element 103 (see FIG. 1A) is hidden from view in FIG. 1B. The hinge pivot element 103 can be any suitable element such as, for example, a bolt, a screw, a pin, a rivet, etc. The attached spring clip 106 is shown with the spring clip 106 fully against the side of the forward flashlight component 101 and the forward attachment component 102. The spring clip 106 can flex and various locations to allow portions of the spring clip 106 to move with respect to the flashlight holder apparatus 100.

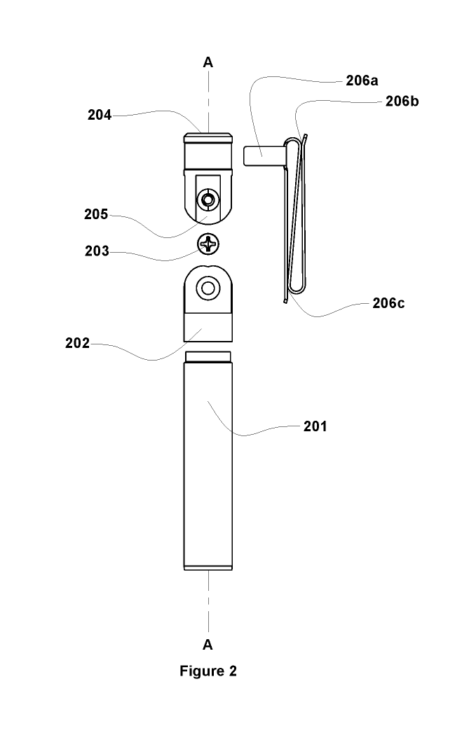

FIG. 2 is a side view of components of an embodiment of a flashlight holding apparatus consistent with embodiments in the present disclosure. FIG. 2 shows a flashlight holder apparatus 200 that comprises a forward flashlight component 201, a forward attachment component 202, a hinge pivot element 203, a magnet 204 coupled with a rear attachment component 205, and a spring clip 206.

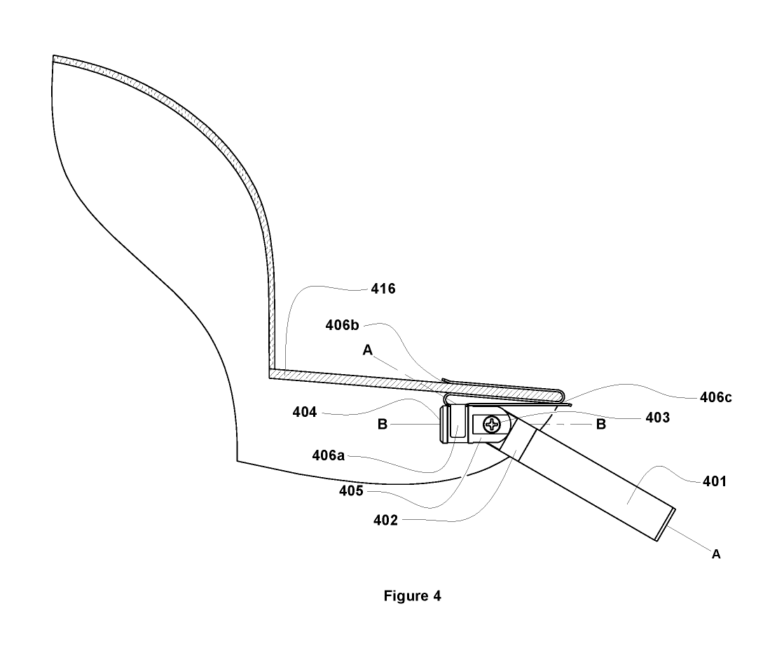

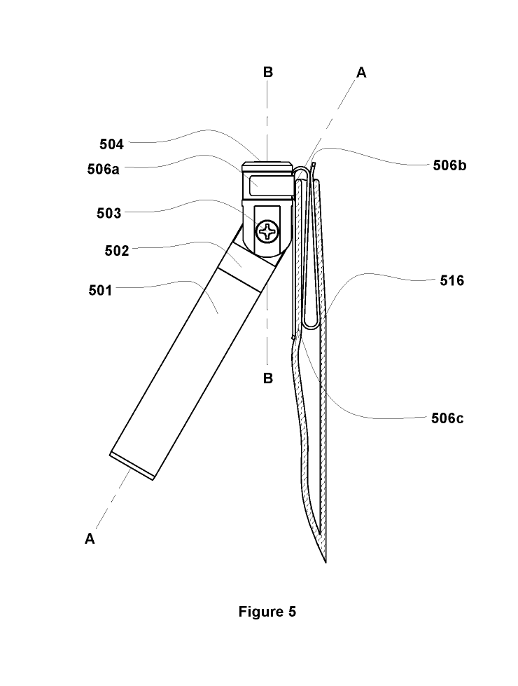

The bi-directional spring clip 206 (i.e., an attachment arrangement) can include a circular portion 206a, a rear spring clip opening 206b and a forward spring clip opening 206c. The rear spring clip opening 206b and the forward spring clip opening 206c can be used to couple the bi-directional spring clip 206 with various objects (see, e.g., FIGS. 4-5 and additional discussion below). The bi-directional spring clip 206 is a generally static attachment arrangement. The clip generally does not move except for some slight deformation when the bi-directional clip 206 is being coupled with an item and/or the item moves/shifts, which may cause additional deflection of the bi-direction spring clip 206.

The magnet 204 (i.e., a second attachment arrangement; a magnetic attachment arrangement) can be any suitable type of magnet in any suitable shape (e.g., round, square, triangular, etc.). The magnet 204 can be coupled with a portion of the rear attachment component 205. The magnet 204 can be secured using any suitable means including adhesive, friction, or portions of the rear attachment component 205 itself (e.g., overmolded polymer, retaining tabs, etc.).

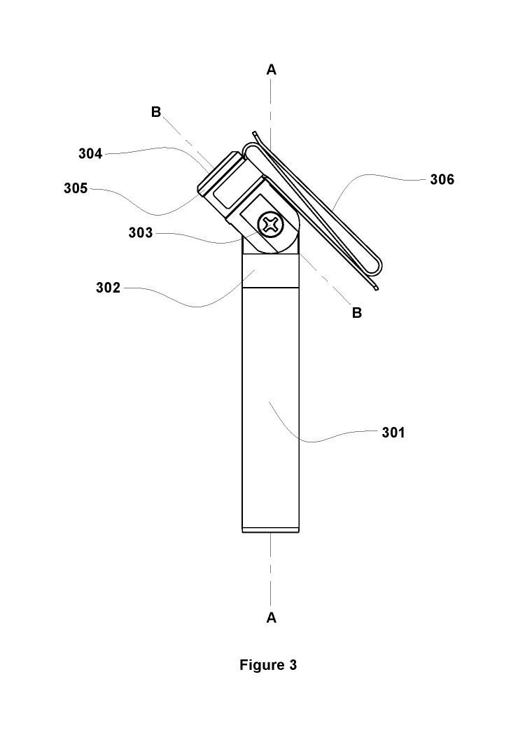

FIG. 3 is a side view of a flashlight holding apparatus in a partially pivoted position, consistent with embodiments in the present disclosure. A flashlight holding apparatus 300 can include a rear attachment component 305 is fully articulated on the hinge pivot element 303 in the direction of the attached spring clip 306 so that the spring clip 306 is fully against the side of the forward flashlight component 301 and the forward attachment component 302.

While in the partially pivoted position (i.e., a first position) the rear attachment component 305 is pivotally coupled, by the hinge pivot element 303, with the forward attachment component 302 where a longitudinal axis of the rear attachment component 305 and the forward attachment component 302 is aligned with the line A-A and a longitudinal axis of the rear attachment component is aligned with a line B-B. In the partially pivoted position the spring clip 306 is not in contact with the side of the forward flashlight component 301 and the forward attachment component 302. If a detent feature is included in the flashlight holding attachment, it can be engaged in this partially pivoted position to maintain the partially pivoted position with a positive force. The range of the pivot motion between the rear attachment component 305 and the forward attachment component 302 can vary an angle between a longitudinal axis defined by the line A-A (i.e., a first longitudinal axis) and a longitudinal axis defined by the line B-B (i.e., a second longitudinal axis) from approximately 0° to 90°. The angle can be adjusted by a user as desired.

FIG. 4 is a side view of a flashlight holding apparatus coupled with a brim of a hat, consistent with embodiments in the present disclosure. A flashlight holding apparatus 400 can comprise a forward flashlight component (i.e., a flashlight assembly) 401, a forward attachment component 402, a hinge pivot element 403, a rear attachment component 405, a rear spring clip mount 407 a rear attachment component 405, and a spring clip 406 (i.e., a bi-directional spring clip) with a rear spring clip mouth 406b.

In FIG. 4. the rear spring clip mouth (406b) has been opened and slid rearward, sliding the spring clip 406 over the leading edge of the brim (416) of a baseball cap until the brim is supporting the flashlight. The forward flashlight component (401) has been subsequently pivoted down and then left in a partially pivoted position.

As shown in FIG. 4, and similar to above, the flashlight holding apparatus 400 can be pivoted with respect to the rear attachment component 405 and the spring clip 406. The range of the pivot motion between the rear attachment component 405 and the forward attachment component 402 can vary an angle between the longitudinal axis defined by the line A-A and the longitudinal axis defined by the line B-B from approximately 0° to 90°. The angle can be adjusted by a user as desired.

Engaging an element with the rear spring clip mouth 406b of the spring clip 406 can be considered a reverse or a rear (or back) position mode of the flashlight holding apparatus 400. It should be noted that the reverse position mode is not limited to use with the brim of a hat. Any item or element that can fit the spring clip 406 will allow coupling of the flashlight holding apparatus with the item or element. Additionally, different sizes of spring clips are possible and could be replaceable to allow for a range of sizes for coupling with different thicknesses of items or elements.

FIG. 5 is a side view of a flashlight holding apparatus coupled with a pocket, consistent with embodiments in the present disclosure. A flashlight holding apparatus 500 can comprise a forward flashlight component (i.e., a flashlight assembly) 501, a forward attachment component 502, a hinge pivot element, a rear attachment component 505, and a spring clip 506 (i.e., a bi-directional spring clip) with a forward spring clip mouth 506c.

As shown in FIG. 5, and similar to above, the flashlight holding apparatus 500 can be pivoted with respect to the rear attachment component 505 and the spring clip 506. The range of the pivot motion between the rear attachment component 505 and the forward attachment component 502 can vary an angle between the longitudinal axis defined by the line A-A and the longitudinal axis defined by the line B-B from approximately 0° to 90°.

In this example the forward spring clip mouth (506c) is slid downward over the upper edge of the front surface of a shirt pocket (516) until the flashlight holding apparatus 500 is supported there by the shirt pocket (516). After attaching the flashlight to the pocket the forward flashlight component (501) is pivoted out away from the pocket (516) and left at the angle which will best train the flashlight beam on the subject to be illuminated.

Engaging an element with the front spring clip mouth 506c of the spring clip 506 can be considered a front position mode of the flashlight holding apparatus 500. It should be noted that the front position mode is not limited to use with the shirt pocket. Any item or element that can fit the spring clip 506 will allow coupling of the flashlight holding apparatus with the item or element.

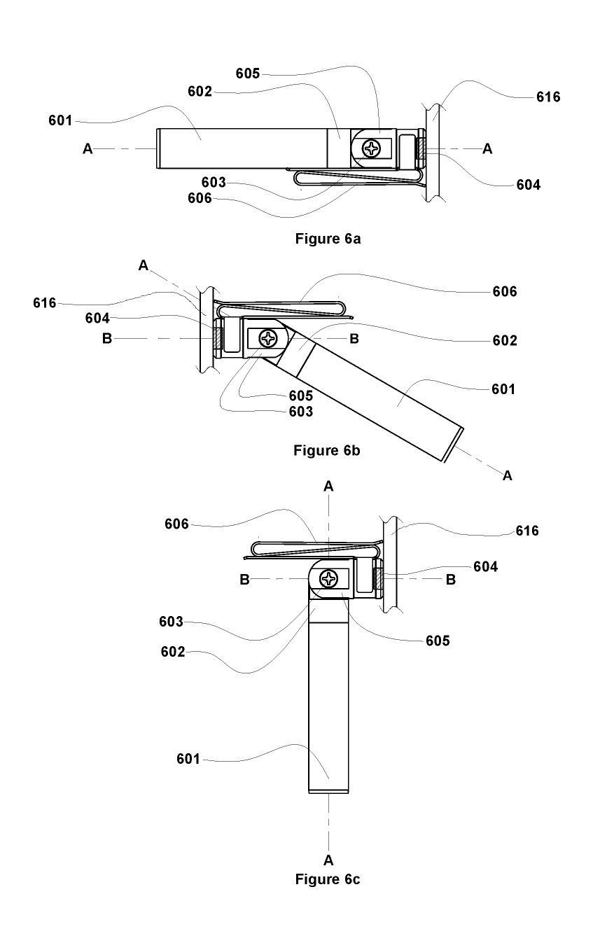

FIGS. 6A-C are side views of three representative configurations of a flashlight holding apparatus using a magnet to couple with an object, consistent with embodiments in the present disclosure. A flashlight holding apparatus 600 can comprise a forward flashlight component 601, a forward attachment component 602, a hinge pivot element 603, a magnet 604 coupled with a rear attachment component 605, and a spring clip 606 (i.e., a bi-directional spring clip).

FIG. 6A shows the flashlight coupled, via the magnet 604, with a ferrous metal surface (616) while in the stowed position therefore positioning the flashlight in a position perpendicular to the metal surface (616).

FIG. 6B shows the flashlight coupled, via the magnet 604, with the metal surface (616) while in the partially pivoted configuration. As shown in FIG. 6B, and similar to above, the flashlight holding apparatus 600 can be pivoted with respect to the rear attachment component 605 and the spring clip 606. The range of the pivot motion between the rear attachment component 605 and the forward attachment component 602 can vary an angle between the longitudinal axis defined by the line A-A and the longitudinal axis defined by the line B-B from approximately 0° to 90°. The angle can be adjusted by a user as desired.

FIG. 6C shows the flashlight coupled, via the magnet 604, with the metal surface (616) with the forward flashlight component (614) having been pivoted a full 90° from the stowed position.

Although at least one embodiment of an apparatus for holding a light has been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the disclosure. Joinder references (e.g., attached, coupled, connected, and the like) are to be construed broadly and can include intermediate members between a connection of elements and relative movement between elements and can also include elements that are part of a mixture or similar configuration. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure can be made without departing from the spirit of the disclosure as defined in the appended claims.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

It will be appreciated that for conciseness and clarity, spatial terms such as “vertical,” “horizontal,” “up,” and “down” may be used herein with respect to the illustrated embodiments. However, flashlight holder apparatuses may be used in many orientations and positions, and these terms are not intended to be limiting and absolute.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A portable light device, comprising:
a body comprising a light; and
an attachment arrangement that is non-reliant on the body comprising the light for attachment functioning, wherein the attachment arrangement is usable in a front position mode, and in a reverse position mode;
wherein the body comprising the light is adjustable in angle relative to the attachment arrangement.

2. A portable light device as in claim 1, wherein the attachment arrangement is a static attachment arrangement, comprising a front attachment position arrangement and a back attachment position arrangement.

3. A portable light device as in claim 2, wherein the front attachment position arrangement and the back attachment position arrangement are opposing attachment position arrangements, within 90 degrees.

4. A portable light device as in claim 2, wherein the device is configured to provide a position wherein the attachment arrangement is aligned directionally with the body comprising the light, and positioned at a side of the body.

5. A portable light device as in claim 1, wherein the attachment arrangement comprises a bi-directional clip.

6. A portable light device as in claim 4, wherein the attachment arrangement comprises a bi-directional clip.

7. A portable light device as claimed in claim 1, wherein the light device comprises a second attachment arrangement.

8. A portable light device as in claim 7, wherein the second attachment arrangement is a magnetic attachment arrangement.

9. A portable light device as in claim 8, wherein the magnetic
attachment arrangement is provided at an opposing end of the light device to the light.

10. A portable light device as in claim 7, wherein the attachment arrangement that is usable in a first position mode and a second position mode, and the second attachment arrangement, are substantially perpendicular to each other, within 25 degrees.

11. A portable light device as in claim 7, wherein the first attachment arrangement that is usable in a first position mode and a second position mode, and the second attachment arrangement, are perpendicular to each other.

12. A portable light device as in claim 1, wherein the light is at the end of the body.

13. A portable light device as in claim 1, wherein the device is a portable flashlight.

14. A portable light device as in claim 13, wherein the device is a portable pocket flashlight.

15. A portable light device as in claim 1, wherein the body comprising the light is elongate.

16. A portable light device as in claim 3, wherein the device is configured to provide a position wherein the attachment arrangement is aligned directionally with the body comprising the light, and positioned at a side of the body.

17. A portable light device as in claim 8, wherein the attachment arrangement that is usable in a first position mode and a second position mode, and the second attachment arrangement, are substantially perpendicular to each other, within 25 degrees.

18. A portable light device as in claim 9, wherein the attachment arrangement that is usable in a first position mode and a second position mode, and the second attachment arrangement, are substantially perpendicular to each other, within 25 degrees.

19. A portable light device as in claim 8, wherein the first attachment arrangement that is usable in a first position mode and a second position mode, and the second attachment arrangement, are perpendicular to each other.

20. A portable light device as in claim 9, wherein the first attachment arrangement that is usable in a first position mode and a second position mode, and the second attachment arrangement, are perpendicular to each other
